(19) United States
(12) Patent Application Publication
(10) Pub. No.: US 2026/0073221 A1
(43) Pub. Date: Mar. 12, 2026

(54) METHOD AND DEVICE FOR MODEL COMPRESSION

(71) Applicants: Hyundai Motor Company, Seoul (KR); Kia Corporation, Seoul (KR)

(72) Inventors: Keonho Lee, Hwaseong-si (KR); Moonsub Jin, Hwaseong-si (KR); Jingang Huh, Hwaseong-si (KR)

(21) Appl. No.: 19/218,779

(22) Filed: May 27, 2025

(30) Foreign Application Priority Data
Sep. 10, 2024 (KR) 10-2024-0123380

(51) Int. Cl. G06N 3/082; G06F 16/901; G06N 3/0495

(52) U.S. Cl. CPC G06N 3/082; G06F 16/9017; G06N 3/0495

(57) ABSTRACT

In an embodiment a method includes receiving a deep learning model loaded on a target device and a computation list supported by a model converter for the target device, determining whether a computation for each layer of the deep learning model is able to be accelerated on the target device based at least in part on the computation list, acquiring a compressed model by maintaining a computation corresponding to one layer as it is, and applying a compression technique to the deep learning model when the one layer of the deep learning model is determined to include a computation unable to be accelerated on the target device, and acquiring the compressed model by changing the computation corresponding to the one layer to another computation, and then applying the compression technique to the deep learning model when the one layer is determined to include the computation able to be accelerated on the target device.

### CROSS-REFERENCE TO RELATED APPLICATIONS

This application claims priority to and the benefit of Korean Patent Application No. 10-2024-0123380 filed in the Korean Intellectual Property Office on Sep. 10, 2024, the entire contents of which are incorporated herein by reference.

### TECHNICAL FIELD

The present disclosure relates to a method and a device for model compression.

### BACKGROUND

A deep learning model shows excellent performance in various fields such as image recognition and natural language processing, which gradually increases its importance. However, the deep learning model requires large-scale computational resources and memory, and is thus mainly operated in a high-performance server environment. On the other hand, usage of the deep learning model may be bound to be very constrained in an environment having constrained computing resources, such as an embedded device. The compression and optimization of the deep learning model may be essential to overcome such an environmental constraint, and various studies are being conducted to reduce a model size and improve a computational speed.

A conventional model compression technique is mainly performed in a server environment with abundant learning resources. In this process, the model is compressed through learning and compression processes, and its performance is evaluated in the server environment. However, this approach has a limitation of insufficiently considering a difference between the embedded environment and the server environment where an actual service is performed. In particular, there may be a difference between a throughput measured in the server environment and an actual throughput in the embedded environment, which indicates that an acceleration effect caused by the model compression may be actually insignificant. In addition, model performance evaluated on public and collected datasets may not translate into qualitative performance in an actual service environment.

### SUMMARY

The present disclosure attempts to provide a method and a device for model compression for eliminating a throughput bottleneck by compression and adaptive learning, and maintaining model performance by using data collected in an embedded environment having constrained computing resources.

According to an embodiment, described is model compression in an embedded environment having a resource-constrained computing environment, including: receiving a deep learning model loaded on a target device and a computation list supported by a model converter for the target device; determining whether a computation for each layer of the deep learning model is able to be accelerated on the target device based on the computation list; acquiring a compressed model by maintaining a computation corresponding to one layer as it is, and applying a compression technique to the deep learning model if the one layer of the deep learning model is determined to include a computation unable to be accelerated on the target device; acquiring the compressed model by changing the computation corresponding to the one layer to another computation, and then applying the compression technique to the deep learning model if the one layer is determined to include the computation able to be accelerated on the target device; and adding a model component of the compressed model to a compressed model component database.

The compressed model component database may be a database for managing the model component of the compressed model by using information on a model name, a model size, the number of model computations, a model inference time, a model definition, and its weight.

The compression technique may include a pruning technique for removing unnecessary weights or neurons from the deep learning model or a depth compression technique for reducing the number of layers in the deep learning model.

The method may further include: evaluating the compressed model by using data used for pre-learning and actual collected data; adding performance information to a performance lookup table database if performance of the compressed model exceeds a predefined performance indicator; and removing the model component of the compressed model from the compressed model component database if the performance of the compressed model does not exceed the predefined performance indicator.

The performance lookup table database may be a database for managing the performance information by using information on a model name, model performance, agreement with an original model, and evaluation metrics.

The evaluation metrics may be computed using Equation 1 below:

$$Evaluation metric = \frac{\{ α A ccuracy * ( 1 - α ) Agreement \} + IAR}{2} . \qquad ( Equation l )$$

Here, “Evaluation metric” indicates the evaluation metrics, “Accuracy” indicates accuracy of the data used for pre-learning, “Agreement” indicates prediction agreement with the actual collected data, “IAR” indicates an inference acceleration rate indicating an improved model inference speed, and a indicates a predetermined constant.

The prediction agreement may be computed using Equation 2 below:

$$Average top - 1 Agreement = \frac{1}{n} {\sum }_{i = 1}^{n} 𝕀 \{ arg max {σ}_{j} ( {z}_{t , i} ) = argmax {σ}_{j} ( {z}_{s , i} ) \} , {σ}_{i} ( z ) = \frac{exp ( {z}_{i} )}{{\sum }_{j} exp ( {z}_{j} )} . \qquad ( Equation 2 )$$

Here, “Average Top-1 Agreement” indicates the prediction agreement, n indicates the number of evaluation data, I indicates a computation that compares these two values and outputs 1 if the values are the same and o if not, argmax indicates an index having a largest value in a list data structure, j indicates the number of classes classified by a total model, z_{t,i} indicates a logit of a pre-trained original model, z_{s,i} indicates a logit of the compressed model, and exp indicates an exponential function.

The inference acceleration rate may be computed using Equation 3 below:

$$IAR = \frac{\begin{matrix}Original Model inference time - \\ Compressed Model inference time\end{matrix}}{Original Model inference time} . \qquad ( Equation 3 )$$

Here, “IAR” indicates the inference acceleration rate, “Original Model inference time” indicates an inference time of a model before the compression, and “Compressed Model inference time” indicates the inference time of the compressed model.

The method may further include: selecting the compressed model by using the performance lookup table database and the compressed model component database; and deploying the selected compressed model.

The selecting of the compressed model may include performing adaptive batch normalization based on the actual collected data, performing sparse update based on Kullback-Leibler (KL) divergence, and updating the performance lookup table database.

According to an embodiment, provided is a device for model compression for performing the model compression in an embedded environment having a resource-constrained computing environment, the device including: at least one processor; and a storage medium storing computer-readable instructions, wherein the instructions are executed by the at least one processor to cause the at least one processor to receive a deep learning model loaded on a target device and a computation list supported by a model converter for the target device, determine whether a computation for each layer of the deep learning model is able to be accelerated on the target device based on the computation list, acquire a compressed model by maintaining a computation corresponding to one layer as it is, and applying a compression technique to the deep learning model if the one layer of the deep learning model is determined to include a computation unable to be accelerated on the target device, acquire the compressed model by changing the computation corresponding to the one layer to another computation, and then applying the compression technique to the deep learning model if the one layer is determined to include the computation able to be accelerated on the target device, and add a model component of the compressed model to a compressed model component database.

The compressed model component database may be a database for managing the model component of the compressed model by using information on a model name, a model size, the number of model computations, a model inference time, a model definition, and its weight.

The compression technique may include a pruning technique for removing unnecessary weights or neurons from the deep learning model or a depth compression technique for reducing the number of layers in the deep learning model.

The instructions may be executed by the at least one processor to cause the at least one processor to further evaluate the compressed model by using data used for pre-learning and actual collected data, add performance information to a performance lookup table database if performance of the compressed model exceeds a predefined performance indicator, and remove the model component of the compressed model from the compressed model component database if the performance of the compressed model does not exceed the predefined performance indicator.

The performance lookup table database may be a database for managing the performance information by using information on a model name, model performance, agreement with an original model, and evaluation metrics.

The evaluation metrics may be computed using Equation 1 below:

$$Evaluation metric = \frac{\{ α A ccuracy * ( 1 - α ) Agreement \} + IAR}{2} . \qquad ( Equation l )$$

Here, “Evaluation metric” indicates the evaluation metrics, “Accuracy” indicates accuracy of the data used for pre-learning, “Agreement” indicates prediction agreement with the actual collected data, “IAR” indicates an inference acceleration rate indicating an improved model inference speed, and a indicates a predetermined constant.

The prediction agreement may be computed using Equation 2 below:

$$Average top - 1 Agreement = \frac{1}{n} {\sum }_{i = 1}^{n} 𝕀 \{ arg max {σ}_{j} ( {z}_{t , i} ) = argmax {σ}_{j} ( {z}_{s , i} ) \} , {σ}_{i} ( z ) = \frac{exp ( {z}_{i} )}{{\sum }_{j} exp ( {z}_{j} )} . \qquad ( Equation 2 )$$

Here, “Average Top-1 Agreement” indicates the prediction agreement, n indicates the number of evaluation data, I indicates a computation that compares these two values and outputs 1 if the values are the same and o if not, argmax indicates an index having a largest value in a list data structure, j indicates the number of classes classified by a total model, z_{t,i} indicates a logit of a pre-trained original model, z_{s,i} indicates a logit of the compressed model, and exp indicates an exponential function.

The inference acceleration rate may be computed using Equation 3 below:

$$IAR = \frac{\begin{matrix}Original Model inference time - \\ Compressed Model inference time\end{matrix}}{Original Model inference time} . \qquad ( Equation 3 )$$

Here, “IAR” indicates the inference acceleration rate, “Original Model inference time” indicates an inference time of a model before the compression, and “Compressed Model inference time” indicates the inference time of the compressed model.

The instructions may be executed by the at least one processor to cause the at least one processor to further select the compressed model by using the performance lookup table database and the compressed model component database, and deploy the selected compressed model.

The at least one processor may select the compressed model by performing adaptive batch normalization based on the actual collected data, performing sparse update based on Kullback-Leibler (KL) divergence, and updating the performance lookup table database.

### BRIEF DESCRIPTION OF THE DRAWINGS

FIG. 1 is a view for describing a device for model compression according to an embodiment.

FIG. 2 is a view for describing a method for model compression according to an embodiment.

FIG. 3 is a view for describing an implementation example of model compression according to an embodiment.

FIG. 4 is a view for describing a method for model compression according to an embodiment.

FIGS. 5 and 6 are views for describing implementation examples of the model compression according to an embodiment.

FIG. 7 is a view for describing the method for model compression according to an embodiment.

FIG. 8 is a view for describing an implementation example of the model compression according to an embodiment.

FIG. 9 is a view for describing a computing device according to an embodiment.

### DETAILED DESCRIPTION OF ILLUSTRATIVE EMBODIMENTS

Hereinafter, embodiments of the present disclosure are described in detail with reference to the accompanying drawings so that those skilled in the art to which the present disclosure pertains may easily practice the present disclosure. However, the present disclosure may be implemented in various different forms and is not constrained to the embodiments provided herein. In addition, in the drawings, portions unrelated to the description are omitted to clearly describe the present disclosure, and similar portions are denoted by similar reference numerals throughout the specification.

Through the specification and claims, unless explicitly described otherwise, “including” any components will be understood to imply the inclusion of another component rather than the exclusion of another component. Terms including ordinal numbers such as “first” and “second” may be used to describe various components. However, these components are not constrained to these terms. These terms are used only to distinguish one component and another component from each other.

Terms such as “˜part”, “˜er/or”, and “module” described in the specification may refer to a unit capable of processing at least one function or operation described in the specification, which may be implemented as hardware, a circuit, software, or a combination of hardware or circuit and software. In addition, at least some components or functions of a method and a device for model compression according to the embodiments described below may be implemented as a program or software, and the program or software may be stored in a computer-readable medium.

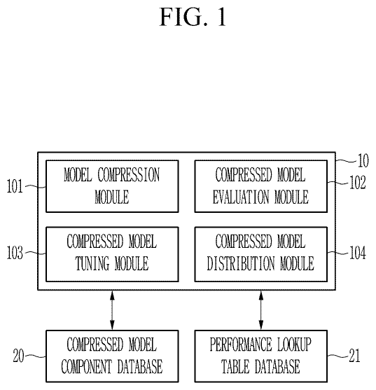

FIG. 1 is a view for describing the device for model compression according to an embodiment.

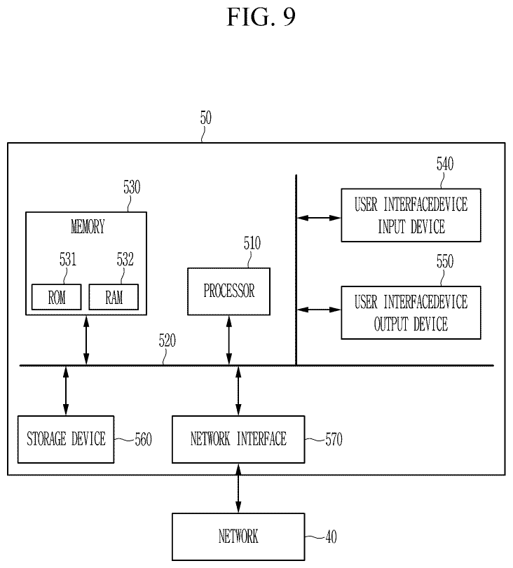

Referring to FIG. 1, a device 10 for model compression according to an embodiment may execute a program code or an instruction, loaded in at least one memory device, through at least one processor. For example, the device 10 for model compression may be implemented as a computing device 50 as described below with reference to FIG. 9. In this case, at least one processor may correspond to a processor 510 of the computing device 50, and at least one memory device may correspond to a memory 520 of the computing device 50. The program code or the instruction may be executed by at least one processor to perform the model compression in an embedded environment having a resource-constrained computing environment. In the specification, a term “module” is used to logically separate such a function performed by the program code or the instruction.

A model trained using a deep learning framework (TensorFlow, Pytorch, MXNet, or the like) may undergo a conversion process by a model converter supported by a target device before the model is deployed to the corresponding device. In this process, an inference speed of the model may be significantly affected by a computation function supported by a converter tool. For example, the inference speed of the corresponding model may be lower than expected if a specific computation is not compatible with a hardware acceleration function of the target device. A conventional model compression technique is mainly performed in a server environment having sufficient learning resources, and a compressed model may be generated through re-learning after applying the compression technique in this environment. However, the server environment and an edge device environment may be different from each other, and an inference speed of the compressed model, evaluated by the number of quantitative model computations (e.g., FLOPs or MACs), may thus be significantly increased or decreased compared to an original model. For example, for a model compressed with an 80% pruning ratio (PR80%), an inference speed acceleration ratio may be greatly changed based on the target device even though an amount of computation and the number of parameters are reduced by 90% or more. This change may occur due to a complex interaction of various factors such as the hardware architecture, computation support range, and memory bandwidth of an edge device. Due to the difference, the compressed model may not achieve the expected performance improvement on the actual edge device even though the model has significantly improved performance in the server environment.

From this perspective, the device 10 for model compression according to an embodiment proposes a method for model compression that considers constraints of the target device, thereby maintaining consistent inference performance in an actual service environment while reducing a model size. For this purpose, the device 10 for model compression may include a model compression module 101, a compressed model evaluation module 102, a compressed model tuning module 103, and a compressed model distribution module 104.

The model compression module 101 may reduce a size of the original model by applying the model compression technique after performing layer conversion such as activation function, pooling, or convolution to enable efficient computation on an embedded device.

In detail, the model compression module 101 may receive a deep learning model loaded on the target device and a computation list supported by the model converter for the target device. The computation list supported by the model converter for the target device may indicate a list of the computation functions that may be optimized for execution on a specific hardware or platform, or various computation tasks associated with a hardware architecture of the target device. Examples of the computation list may include matrix multiplication, two-dimensional (2D) and three-dimensional (3D) convolutions, activation functions such as ReLU, pooling computations such as max pooling and average pooling, normalization computations such as batch normalization and layer normalization, and further include basic arithmetic computations such as addition and multiplication, recurrent neural network computations such as recurrent neural network (RNN) or long short-term memory (LSTM), and computations such as attention.

The model compression module 101 may determine whether the computation for each layer of the deep learning model may be accelerated on the target device based on the computation list. That is, the model compression module 101 may profile a deep learning model inference process on the target device to overcome a difference in the throughput between the server environment where the deep learning model is compressed and an edge environment where the model is actually deployed. Through this configuration, the model compression module 101 may identify a bottleneck occurring in the inference process and analyze whether each layer of the deep learning model may be supported based on the computation list supported by the model converter input to the target device.

The model compression module 101 may acquire the compressed model by maintaining the computation corresponding to one layer as it is and applying the compression technique to the deep learning model if one layer of the deep learning model is determined to include a computation unable to be accelerated on the target device. On the other hand, the model compression module 101 may acquire the compressed model by changing the computation corresponding to the corresponding layer to another computation and then applying the compression technique to the deep learning model if the corresponding layer of the deep learning model is determined to include a computation able to be accelerated on the target device. In some embodiments, the compression technique may include a pruning technique for removing unnecessary weights or neurons from the deep learning model or a depth compression technique for reducing the number of layers in the deep learning model.

For example, if a specific layer of the deep learning model includes the computation unable to be accelerated on the target device, the model compression module 101 may apply the compression technique such as the pruning or the depth compression and measure the throughput of the corresponding layer. The model compression module 101 may repeatedly perform this process until an inference speed of the layer is reduced by, for example, 10% to 90% of the original model, thereby finding the optimal compression level. On the other hand, for a layer that includes the computation able to be accelerated, the model compression module 101 may apply the compression technique after replacing the computation with a more efficient computation, and measure the throughput in the same way. The model compression module 101 may repeatedly perform the model compression and the optimization process in consideration of the target device for each layer of the deep learning model.

The model compression module 101 may add a model component of the acquired compressed model to a compressed model component database 20. Here, the compressed model component database 20 may be a database for managing the model component of the compressed model by using information on various elements that configure the deep learning model, such as a model name, the model size, the number of model computations, a model inference time, a model definition, and its weight.

The compressed model evaluation module 102 may evaluate whether the compressed model is suitable for a target embedded device through various indicators such as a delay time, accuracy, and mean average precision (mAP) by using public data and data collected from an actual environment.

In detail, the compressed model evaluation module 102 may evaluate the compressed model by using data used for pre-learning and actual collected data. In some embodiments, the data used for pre-learning may include the public data.

The compressed model evaluation module 102 may add performance information to a performance lookup table database 21 if performance of the compressed model exceeds a predefined performance indicator, and remove the model component of the compressed model from the compressed model component database 20 if the performance of the compressed model does not exceed the predefined performance indicator. Here, the performance lookup table database 21 may be a database for managing the performance information by using information on the model name, model performance, agreement with the original model, and evaluation metrics.

In some embodiments, the evaluation metrics may be computed using Equation 1 below:

$$Evaluation metric = \frac{\{ α A ccuracy * ( 1 - α ) Agreement \} + IAR}{2} . \qquad ( Equation l )$$

Here, “Evaluation metric” indicates the evaluation metrics, “Accuracy” indicates accuracy of the data used for pre-learning, “Agreement” indicates prediction agreement with the actual collected data, “IAR” indicates an inference acceleration rate indicating an improved model inference speed, and a indicates a predetermined constant.

In some embodiments, the prediction agreement may be computed using Equation 2 below:

$$Average top - 1 Agreement = \frac{1}{n} {\sum }_{i = 1}^{n} 𝕀 \{ arg max {σ}_{j} ( {z}_{t , i} ) = argmax {σ}_{j} ( {z}_{s , i} ) \} , {σ}_{i} ( z ) = \frac{exp ( {z}_{i} )}{{\sum }_{j} exp ( {z}_{j} )} . \qquad ( Equation 2 )$$

Here, “Average Top-1 Agreement” indicates the prediction agreement, n indicates the number of evaluation data, I indicates a computation that compares these two values and outputs 1 if the values are the same and o if not, argmax indicates an index having the largest value in a list data structure, j indicates the number of classes classified by a total model, z_{t,i} indicates a logit of the pre-trained original model, z_{s,i} indicates a logit of the compressed model, and exp indicates an exponential function.

In some embodiments, the inference acceleration rate may be computed using Equation 3 below:

$$IAR = \frac{\begin{matrix}Original Model inference time - \\ Compressed Model inference time\end{matrix}}{Original Model inference time} . \qquad ( Equation 3 )$$

Here, “IAR” indicates the inference acceleration rate, “Original Model inference time” indicates an inference time of the model before the compression, and “Compressed Model inference time” indicates an inference time of the compressed model.

The predefined performance indicator indicates the top a % of evaluation scores, where “a” may be a value that a user may set. The compressed model evaluation module 102 may store the performance in the performance lookup table database 21 based on the predefined performance indicator, and remove the corresponding model component from the compressed model component database 20 if the performance indicator is the top a % or less.

The compressed model tuning module 103 may re-adjust the parameter of the compressed model by using the actual collected data. In detail, the compressed model tuning module 103 may select the compressed model by using the performance lookup table database 21 and the compressed model component database 20, acquired from the compressed model evaluation module 102.

In some embodiments, the compressed model tuning module 103 may perform adaptive batch normalization based on the actual collected data to thus recover performance degradation caused by application of the compression technique and enable rapid adaptation to the actual data. Here, the adaptive batch normalization may indicate update of the mean and standard deviation excluding a learnable parameter in a batch normalization equation.

The compressed model tuning module 103 may perform primary performance recovery by applying the adaptive batch normalization that uses only the data without learning, perform sparse update based on Kullback-Leibler (KL) divergence, and then update the performance lookup table database 21. That is, the compressed model tuning module 103 may determine which weights to update through sensitivity analysis based on the original model and a KL divergence loss, perform the KL-based sparse update, update the performance lookup table database 21, and then select the compressed model suitable for the actual service environment rather than updating all the weights of the model when training the compressed model in consideration of constraints of the computing resources.

The compressed model distribution module 104 may deploy the compressed model selected through the above process.

According to the embodiments, a server infrastructure cost may be reduced because the compression is achieved with a little tuning including the parameter adjustment in the embedded environment through an online method, unlike an offline model compression technique that is performed in the server environment that requires the sufficient learning resources. In addition, a data labeling cost may be reduced in the online method because the model is tuned using data collected during an actual service process and requires no separate data labeling during the process. In addition, an appropriate compression technique may be applied for each target embedded environment to thus make a real-time inference possible even in the environment having the constrained resources, and may be effectively applied to various systems having different hardware platforms.

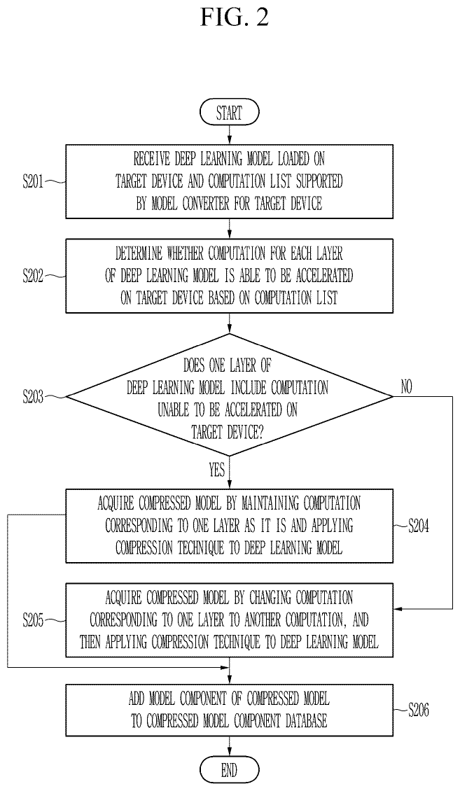

FIG. 2 is a view for describing a method for model compression according to an embodiment.

Referring to FIG. 2, the method for model compression according to an embodiment may include: receiving a deep learning model loaded on a target device and a computation list supported by a model converter for the target device (S201); determining whether a computation for each layer of the deep learning model is able to be accelerated on the target device based on the computation list (S202); and determining whether one layer of the deep learning model includes a computation unable to be accelerated on the target device (S203).

The method may include: acquiring a compressed model by maintaining a computation corresponding to one layer as it is and applying a compression technique to the deep learning model (S204); and adding a model component of the compressed model to a compressed model component database (S206) if one layer of the deep learning model is determined to be a computation unable to be accelerated on the target device (‘Y’ in S203).

The method may include: acquiring the compressed model by changing the computation corresponding to one layer to another computation, and then applying the compression technique to the deep learning model (S205); and adding the model component of the compressed model to the compressed model component database (S206) if one layer of the deep learning model is determined not to be the computation unable to be accelerated on the target device (‘N’ in S203).

For more detailed information on the method, it is possible to refer to the descriptions of the embodiments described in the specification, and the description thus omits their redundant descriptions here.

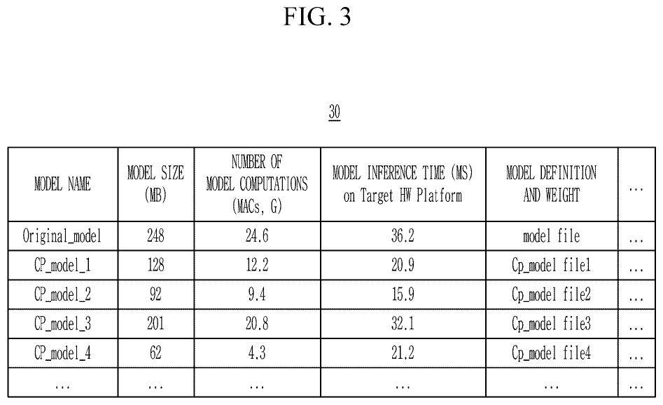

FIG. 3 is a view for describing an implementation example of model compression according to an embodiment.

Referring to FIG. 3, a compressed model component database 30 according to an embodiment may include the information on the various elements that configure the deep learning model, such as the model name, the model size, the number of model computations, the model inference time, the model definition, and its weight. For example, for a model “Original_model” before the compression, the model definition and its weight may be defined as “modelfile”. For the corresponding model, the model size may be 248, the number of model computations may be 24.6, and the model inference time may be 36.2, which may be stored in the compressed model component database 30. In addition, for compressed models “Cp_model_1”, “Cp_model_2”, “Cp_model_3”, and “Cp_model_4”, the model definitions and weights may be defined as “Cp_model file1”, “Cp_model file2”, “Cp_model file3”, and “Cp_model file4”, and the model size, the number of model computations, and the model inference time for each model may be stored in the compressed model component database 30. As shown in the drawing, “Cp_model_4” may be the minimum in terms of the model size and the number of model computations, and “Cp_model_2” may be the minimum in terms of the model inference time.

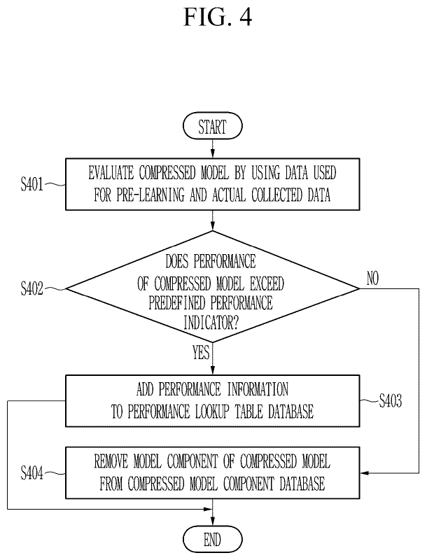

FIG. 4 is a view for describing a method for model compression according to an embodiment.

Referring to FIG. 4, the method for model compression according to an embodiment may include: evaluating a compressed model by using data used for pre-learning and actual collected data (S401); and determining whether performance of the compressed model exceeds a predefined performance indicator (S402).

The method may include adding performance information to a performance lookup table database (S403) if the performance of the compressed model is determined to exceed the predefined performance indicator (‘Y’ in S402).

The method may include removing a model component of the compressed model from a compressed model component database (S404) if the performance of the compressed model is determined not to exceed the predefined performance indicator (‘N’ in S402).

For more detailed information on the method, it is possible to refer to the descriptions of the embodiments described in the specification, and the description thus omits their redundant descriptions here.

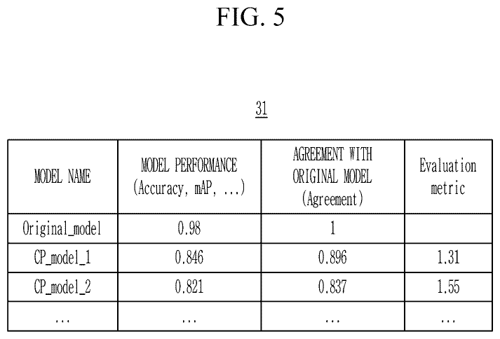

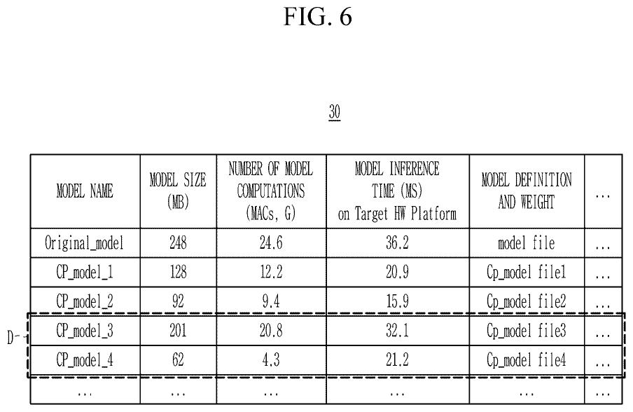

FIGS. 5 and 6 are views for describing implementation examples of the model compression according to an embodiment.

Referring to FIG. 5, a performance lookup table database 31 according to an embodiment may include the information on the model name, the model performance, the agreement with the original model, and the evaluation metrics. For example, for the model “Original_model” before the compression, the model performance may be 0.98, the agreement with the original model may be 1, and these values may be stored in the performance lookup table database 31. In addition, for each of the compressed models “Cp_model_1” and “Cp_model_2”, the model performance, the agreement with the original model, and the evaluation metrics may be stored in the performance lookup table database 31.

Referring to FIG. 6, the evaluation metrics may be sorted according to a predefined criterion in the performance lookup table database 31, and then the compression models “Cp_model_3” and “Cp_model_4” marked as region D may be removed from the compressed model component database 30. That is, the compression models “Cp_model_3” and “Cp_model_4” may be removed from the compressed model component database 30 because their performances do not exceed the predefined performance indicator.

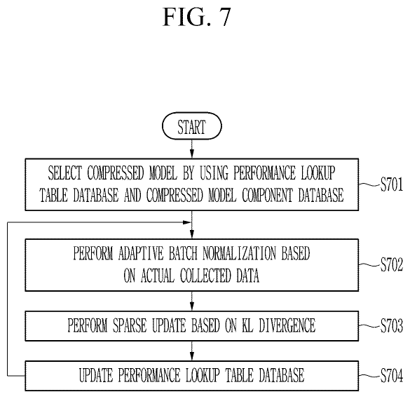

FIG. 7 is a view for describing a method for model compression according to an embodiment.

Referring to FIG. 7, the method for model compression according to an embodiment may include: selecting a compressed model by using a performance lookup table database and a compressed model component database (S701); performing adaptive batch normalization based on actual collected data (S702); performing sparse update based on Kullback-Leibler (KL) divergence (S703); and updating the performance lookup table database (S704). The method may repeat the process of performing step (S702) again after step (S704).

For more detailed information on the method, it is possible to refer to the descriptions of the embodiments described in the specification, and the description thus omits their redundant descriptions here.

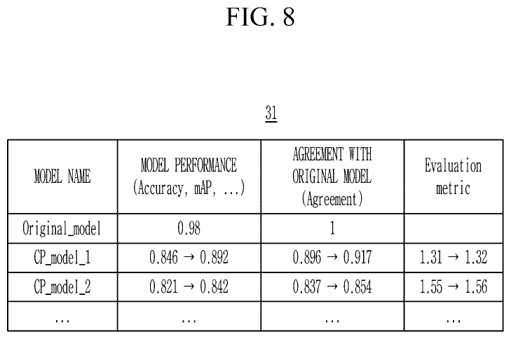

FIG. 8 is a view for describing an implementation example of the model compression according to an embodiment.

FIG. 8 shows an example result in which the performance lookup table database is updated by selecting the compressed model using the performance lookup table database and the compressed model component database, and then selecting the weight to be updated by performing the adaptive batch normalization. For the compressed model “Cp_model_1”, the model performance may be updated from 0.846 to 0.892, the agreement with the original model may be updated from 0.896 to 0.917, and the evaluation metrics may be updated from 1.31 to 1.32. Meanwhile, for the compressed model “Cp_model_2”, the model performance may be updated from 0.821 to 0.842, the agreement with the original model may be updated from 0.837 to 0.854, and the evaluation metrics may be updated from 1.55 to 1.56.

FIG. 9 is a view for describing a computing device according to an embodiment.

Referring to FIG. 9, the method and the device for model compression according to the embodiments may be implemented using the computing device 50. The computing device 50 may be implemented as any of various types of electronic devices, servers, or similar devices, and its function may be implemented through a combination of software and hardware.

The computing device 50 may include at least one of the processor 510, a memory 530, a user interface input device 540, a user interface output device 550, and a storage device 560, performing their communications with one another using a bus 520. The computing device 50 may also include a network interface 570 electrically connected to a network 40. The network interface 570 may transmit or receive a signal with another entity through the network 40.

The processor 510 may be implemented as any of various types of computing devices, such as a micro controller unit (MCU), an application processor (AP), a central processing unit (CPU), a graphic processing unit (GPU), a neural processing unit (NPU), or a quantum processing unit (QPU). The processor 510 may also be a semiconductor device that executes an instruction stored in the memory 530 or the storage device 560, and may perform a core function of a system. A program code and data stored in the memory 530 or the storage device 560 may instruct the processor 510 to perform a specific task, thereby enabling overall operations of the system. In this way, the processor 510 may be configured to implement the various functions and methods described above with reference to FIGS. 1 to 8.

The memory 530 and the storage device 560 may include various types of volatile or non-volatile storage media for storing and accessing data in the system. For example, the memory 530 may include a read only memory (ROM) 531 and a random access memory (RAM) 532. In some embodiments, the memory 530 may be embedded in the processor 510, in which case data transmission between the memory 530 and the processor 510 may be performed at a very high speed. In some other embodiments, the memory 530 may be disposed outside the processor 510, in which case the memory 530 may be connected to the processor 510 through various data buses or interfaces. This connection may be made by various means already known, for example, through a peripheral component interconnect express (PCIe) interface for the high-speed data transmission or through a memory controller.

In some embodiments, at least some components or functions of the method and the device for model compression according to the embodiments may be implemented as a program or software executed on the computing device 50, and the program or software may be stored in a computer-readable medium. In detail, the computer-readable medium according to an embodiment may have a program recorded for executing steps included in the method and the device for model compression according to the embodiments that is recoded on a computer including the processor 510 executing the program or the instruction, stored in the memory 530 or the storage device 560.

In some embodiments, at least some components or functions of the method and the device for model compression according to the embodiments may be implemented using hardware or circuitry of the computing device 50, or implemented using a separate hardware or circuitry that may be electrically connected to the computing device 50.

According to the embodiments, the server infrastructure cost may be reduced because the compression is achieved with a little tuning including the parameter adjustment in the embedded environment through the online method, unlike the offline model compression technique that is performed in the server environment that requires the sufficient learning resources. In addition, the data labeling cost may be reduced in the online method because the model is tuned using the data collected during the actual service process and requires no separate data labeling during the process. In addition, the appropriate compression technique may be applied for each target embedded environment to thus make the real-time inference possible even in the environment having the constrained resources, and may be effectively applied to the various systems having the different hardware platforms.

Although the embodiments of the present disclosure have been described in detail hereinabove, the scope of the present disclosure is not constrained thereto, and various modifications and alterations made by those skilled in the art to which the present disclosure pertains by using a basic concept of the present disclosure as defined in the following claims also fall within the scope of the present disclosure.

What is claimed is:

1. A method comprising:
receiving a deep learning model loaded on a target device and a computation list supported by a model converter for the target device;
determining whether a computation for each layer of the deep learning model is able to be accelerated on the target device based at least in part on the computation list;
acquiring a compressed model by maintaining a computation corresponding to one layer as it is, and applying a compression technique to the deep learning model when the one layer of the deep learning model is determined to include a computation unable to be accelerated on the target device;
acquiring the compressed model by changing the computation corresponding to the one layer to another computation, and then applying the compression technique to the deep learning model when the one layer is determined to include the computation able to be accelerated on the target device; and
adding a model component of the compressed model to a compressed model component database.

2. The method of claim 1, wherein the compressed model component database includes a database for managing the model component of the compressed model by using information on a model name, a model size, the number of model computations, a model inference time, a model definition, and its weight.

3. The method of claim 1, wherein the compression technique includes a pruning technique for removing weights or neurons from the deep learning model or a depth compression technique for reducing the number of layers in the deep learning model.

4. The method of claim 1, further comprising:
evaluating the compressed model by using data used for pre-learning and actual collected data;
adding performance information to a performance lookup table database when performance of the compressed model exceeds a predefined performance indicator; and
removing the model component of the compressed model from the compressed model component database when the performance of the compressed model does not exceed the predefined performance indicator.

5. The method of claim 4, wherein the performance lookup table database is a database for managing the performance information by using information on a model name, model performance, agreement with an original model, and evaluation metrics.

6. The method of claim 5, wherein the evaluation metrics are computed based at least in part on a computational approach corresponding to Equation 1 below:
$$Evaluation metric = \frac{\{ α A ccuracy * ( 1 - α ) Agreement \} + IAR}{2} , \qquad ( Equation l )$$
wherein, Evaluation metric indicates the evaluation metrics, Accuracy indicates accuracy of data used for pre-learning, Agreement indicates prediction agreement with the actual collected data, IAR indicates an inference acceleration rate indicating an improved model inference speed, and a indicates a predetermined constant.

7. The method of claim 6, wherein the prediction agreement is computed based at least in part on a computational approach corresponding to Equation 2 below:
$$Average top - 1 Agreement = \frac{1}{n} {\sum }_{i = 1}^{n} 𝕀 \{ arg max {σ}_{j} ( {z}_{t , i} ) = argmax {σ}_{j} ( {z}_{s , i} ) \} , {σ}_{i} ( z ) = \frac{exp ( {z}_{i} )}{{\sum }_{j} exp ( {z}_{j} )} , \qquad ( Equation 2 )$$
wherein, Average Top-1 Agreement indicates the prediction agreement, n indicates the number of evaluation data, I indicates a computation that compares these two values and outputs 1 when the values are the same and o when not, argmax indicates an index having a largest value in a list data structure, j indicates the number of classes classified by a total model, z_{t,i} indicates a logit of a pre-trained original model, z_{s,i} indicates a logit of the compressed model, and exp indicates an exponential function.

8. The method of claim 6, wherein the inference acceleration rate is computed based at least in part on a computational approach corresponding to Equation 3 below:
$$IAR = \frac{\begin{matrix}Original Model inference time - \\ Compressed Model inference time\end{matrix}}{Original Model inference time} , \qquad ( Equation 3 )$$
wherein, IAR indicates the inference acceleration rate, Original Model inference time indicates an inference time of a model before the compression, and Compressed Model inference time indicates the inference time of the compressed model.

9. The method of claim 4, further comprising:
selecting the compressed model by using the performance lookup table database and the compressed model component database; and
deploying the selected compressed model.

10. The method of claim 9, wherein selecting the compressed model comprises:
performing adaptive batch normalization based at least in part on the actual collected data,
performing sparse update based at least in part on a computational approach corresponding to Kullback-Leibler (KL) divergence, and
updating the performance lookup table database.

11. A device comprising:
at least one processor; and
a storage medium storing computer-readable instructions,
wherein the instructions are executed by the at least one processor to cause the at least one processor to:
receive a deep learning model loaded on a target device and a computation list supported by a model converter for the target device,
determine whether a computation for each layer of the deep learning model is able to be accelerated on the target device based at least in part on the computation list,
acquire a compressed model by maintaining a computation corresponding to one layer as it is, and applying a compression technique to the deep learning model when the one layer of the deep learning model is determined to include a computation unable to be accelerated on the target device,
acquire the compressed model by changing the computation corresponding to the one layer to another computation, and then applying the compression technique to the deep learning model when the one layer is determined to include the computation able to be accelerated on the target device, and
add a model component of the compressed model to a compressed model component database.

12. The device of claim 11, wherein the compressed model component database is a database for managing the model component of the compressed model by using information on a model name, a model size, the number of model computations, a model inference time, a model definition, and its weight.

13. The device of claim 11, wherein the compression technique includes a pruning technique for removing weights or neurons from the deep learning model or a depth compression technique for reducing the number of layers in the deep learning model.

14. The device of claim 11, wherein the instructions are executable by the at least one processor to cause the at least one processor to further:
evaluate the compressed model by using data used for pre-learning and actual collected data,
add performance information to a performance lookup table database when performance of the compressed model exceeds a predefined performance indicator, and
remove the model component of the compressed model from the compressed model component database when the performance of the compressed model does not exceed the predefined performance indicator.

15. The device of claim 14, wherein the performance lookup table database is a database for managing the performance information by using information on a model name, model performance, agreement with an original model, and evaluation metrics.

16. The device of claim 15, wherein the evaluation metrics are computable based at least in part on a computational approach corresponding to Equation 1 below:
$$Evaluation metric = \frac{\{ α A ccuracy * ( 1 - α ) Agreement \} + IAR}{2} , \qquad ( Equation l )$$
wherein Evaluation metric indicates the evaluation metrics, Accuracy indicates accuracy of the data used for pre-learning, Agreement indicates prediction agreement with the actual collected data, IAR indicates an inference acceleration rate indicating an improved model inference speed, and a indicates a predetermined constant.

17. The device of claim 16, wherein the prediction agreement is computable based at least in part on a computational approach corresponding to Equation 2 below:
$$Average top - 1 Agreement = \frac{1}{n} {\sum }_{i = 1}^{n} 𝕀 \{ arg max {σ}_{j} ( {z}_{t , i} ) = argmax {σ}_{j} ( {z}_{s , i} ) \} , {σ}_{i} ( z ) = \frac{exp ( {z}_{i} )}{{\sum }_{j} exp ( {z}_{j} )} , \qquad ( Equation 2 )$$
wherein, Average Top-1 Agreement indicates the prediction agreement, n indicates the number of evaluation data, I indicates a computation that compares these two values and outputs 1 when the values are the same and o when not, argmax indicates an index having a largest value in a list data structure, j indicates the number of classes classified by a total model, z_{t,i} indicates a logit of a pre-trained original model, z_{s,i} indicates a logit of the compressed model, and exp indicates an exponential function.

18. The device of claim 16, wherein the inference acceleration rate is computable based at least in part on a computational approach corresponding to Equation 3 below:
$$IAR = \frac{\begin{matrix}Original Model inference time - \\ Compressed Model inference time\end{matrix}}{Original Model inference time} , \qquad ( Equation 3 )$$
wherein, IAR indicates the inference acceleration rate, Original Model inference time indicates an inference time of a model before the compression, and Compressed Model inference time indicates the inference time of the compressed model.

19. The device of claim 14, wherein the instructions are executed by the at least one processor to cause the at least one processor to further:
select the compressed model by using the performance lookup table database and the compressed model component database, and
deploy the selected compressed model.

20. The device of claim 19, wherein the at least one processor is configured to select the compressed model by:
performing adaptive batch normalization based at least in part on the actual collected data,
performing sparse update based at least in part on a computational approach corresponding to Kullback-Leibler (KL) divergence, and
updating the performance lookup table database.
